(19) United States
(12) Patent Application Publication
(10) Pub. No.: US 2026/0169400 A1
(43) Pub. Date: Jun. 18, 2026

(54) IMAGE FORMING APPARATUS

(71) Applicant: Yasuhiro FUJIWARA, Kanagawa (JP)

(72) Inventor: Yasuhiro FUJIWARA, Kanagawa (JP)

(73) Assignee: ETRIA Co., Ltd., Kanagawa (JP)

(21) Appl. No.: 19/404,557

(22) Filed: Dec. 1, 2025

(30) Foreign Application Priority Data
Dec. 18, 2024 (JP) 2024-221949

(51) Int. Cl. G03G 15/01; G03G 15/00; G03G 21/00; G03G 21/02

(52) U.S. Cl. CPC G03G 15/0136; G03G 15/0189; G03G 15/5012; G03G 15/556; G03G 21/0005; G03G 21/02

(57) ABSTRACT

An image forming apparatus includes an image bearer; multiple image forming stations, each including a latent image bearer; a transfer member; a cleaning member to clean the image bearer; and control circuitry to control the image forming apparatus to operate in a first mode in which a toner image is formed by one image forming station and a second mode in which a toner image is formed by the multiple image forming stations. The circuitry executes formation, on the image bearer, of a toner image pattern to be input to the cleaning member based on an indicator value calculated by multiplying an indicator value conversion coefficient by a travel distance of the latent image bearer in the second mode or a number of printed sheets in the second mode, and changes the indicator value conversion coefficient based on an operation ratio of the second mode during a predetermined period.

### CROSS-REFERENCE TO RELATED APPLICATIONS

This patent application is based on and claims priority pursuant to 35 U.S.C. § 119(a) to Japanese Patent Application No. 2024-221949, filed on Dec. 18, 2024, in the Japan Patent Office, the entire disclosure of which is hereby incorporated by reference herein.

### BACKGROUND

### Technical Field

The present disclosure relates to an image forming apparatus.

### Related Art

There is an image forming apparatus including: an image bearer that bears a toner image, multiple image forming units that form the toner image on the image bearer, a transfer member that transfers the toner image of the image bearer to a sheet; and a cleaning member that cleans a surface of the image bearer, a toner image pattern input to the cleaning member being formed on the image bearer.

For example, as an image forming apparatus of a related art, an image forming apparatus in which a toner image pattern for removing filming of an intermediate transfer belt as an image bearer is formed and the toner image pattern is input to a contact part between a cleaning member and the intermediate transfer belt is described. The toner image pattern is formed based on an indicator value indicating a filming amount on the surface of the intermediate transfer belt. Specifically, the indicator value is calculated by multiplying the travel distance of the intermediate transfer belt by an indicator value conversion coefficient.

The indicator value conversion coefficient is different between a color image mode as a second mode in which a full-color image is formed on the intermediate transfer belt using an image forming station which is multiple image forming units and a monochrome image mode as a first mode in which a black toner image is formed on the intermediate transfer belt using only a black image forming station among multiple image forming stations, and the indicator value conversion coefficient of the color image mode in which filming is more likely to deteriorate is made higher than the indicator value conversion coefficient of the monochrome image mode.

In the monochrome image mode, the indicator value is calculated using the indicator value conversion coefficient of the monochrome image mode. In the color image mode, the indicator value is calculated using the indicator value conversion coefficient of the color image mode. Then, when the cumulative value of the calculated indicator value exceeds a threshold, a toner image pattern is formed. It has been proposed that by making the indicator value conversion coefficient of the color image mode in which filming is more likely to deteriorate higher than the indicator value conversion coefficient of the monochrome image mode, a toner image can be formed at an appropriate timing, and deterioration of filming and wasteful toner consumption can be reduced.

### SUMMARY

The present disclosure described herein provides an image forming apparatus including an image bearer to bear a toner image; multiple image forming stations to form the toner image on the image bearer, each of the multiple image forming stations including a latent image bearer; a transfer member to transfer the toner image from the image bearer onto a sheet; a cleaning member to clean a surface of the image bearer; and control circuitry. The control circuitry is to control the image forming apparatus to operate in a first mode in which the toner image is formed on the image bearer by one image forming station of the multiple image forming stations and a second mode in which the toner image is formed on the image bearer by the multiple image forming stations. The circuitry executes formation, on the image bearer, of a toner image pattern to be input to the cleaning member based on an indicator value, the indicator value being calculated by multiplying an indicator value conversion coefficient by either a travel distance of the respective latent image bearers of the multiple image forming stations in the second mode or a number of printed sheets in the second mode, and changes the indicator value conversion coefficient based on an operation ratio of the second mode during a predetermined period.

The present disclosure described herein provides an image forming apparatus including an image bearer to bear a toner image; multiple image forming stations to form the toner image on the image bearer, each of the multiple image forming stations including a latent image bearer; a transfer member to transfer the toner image from the image bearer onto a sheet; a cleaning member to clean a surface of the image bearer; and control circuitry. The control circuitry is to control the image forming apparatus to operate in a first mode in which the toner image is formed on the image bearer by one image forming station of the multiple image forming stations and a second mode in which the toner image is formed on the image bearer by the multiple image forming stations. The circuitry controls formation, on the image bearer, of a toner image pattern to be input to the cleaning member. In a case that a required toner input amount calculated based on an indicator value and a toner amount of the toner image pattern input to the cleaning member exceeds a threshold, the circuitry determines whether to form the toner image pattern or to skip formation of the toner image pattern, and set a number of times of skipping formation of the toner image pattern based on an operation ratio of the second mode during a predetermined period, the indicator value being calculated by multiplying an indicator value conversion coefficient by either a travel distance of the latent image bearers of the multiple image forming stations in the second mode or a number of printed sheets in the second mode.

The present disclosure described herein provides a method for forming an image by an image forming apparatus having a first mode in which a toner image is formed on an image bearer by one of multiple image forming station, and a second mode in which the toner image is formed on the image bearer by the multiple image forming stations. The method includes forming a toner image pattern to be input to a cleaning member on the image bearer, based on an indicator value, the indicator value being calculated by multiplying an indicator value conversion coefficient by either a travel distance of respective latent image bearers of the multiple image forming stations in the second mode or a number of printed sheets in the second mode, wherein the indicator value conversion coefficient is changed based on an operation ratio of the second mode during a predetermined period.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram of a color laser printer which is an image forming apparatus;

FIG. 2 is a schematic configuration diagram of a copying machine which is another example of the image forming apparatus;

FIG. 3 is a control block diagram of a printer;

FIGS. 4A to 4C are graphs illustrating a relationship over time between a ratio of an input toner shortage and belt filming;

FIG. 5 is an input amount calculation flowchart according to Example 1;

FIG. 6 is a table illustrating a relationship among a formation timing of a scraping toner pattern, a frequency of each formation timing, and a travel distance of an image formation related member;

FIGS. 7A to 7B are diagrams illustrating an operation after the end of printing in a monochrome image forming mode;

FIGS. 8A to 8B are diagrams illustrating an operation after the end of printing in a full-color image forming mode;

FIG. 9 is a diagram illustrating evaluation by adjustment of a toner input amount to a cleaning blade of a belt cleaning device in a predetermined period for each formation timing of the scraping toner pattern;

FIG. 10A is a table illustrating a formation frequency of the scraping toner pattern at each formation timing in Example 2;

FIG. 10B is a table illustrating a toner amount of the scraping toner pattern at each formation timing in Example 2; and

FIG. 11 is a flowchart for determining formation of the scraping toner pattern during a printing operation in Example 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

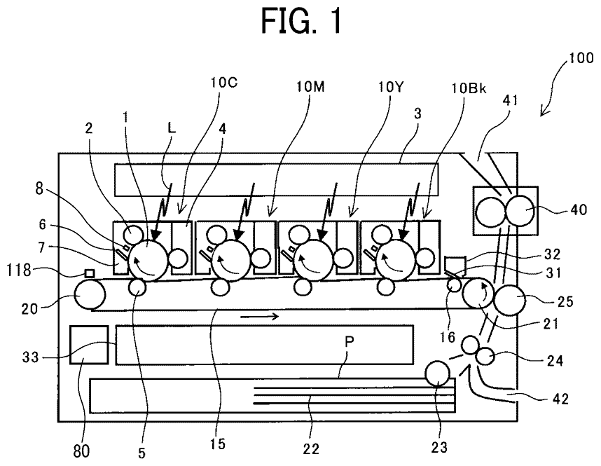

FIG. 1 is a diagram illustrating a schematic configuration of a color laser printer (may be referred to as the “printer”) which is an image forming apparatus.

A printer 100 illustrated in this drawing includes an intermediate transfer belt 15 that is an image bearer and an intermediate transfer member. Image forming stations (image forming units) 10 as four image forming units for forming toner images of respective colors of black (K), yellow (Y), magenta (M), and cyan (C) are juxtaposed along an upper traveling side of the intermediate transfer belt 15 to form a tandem image former.

In a full-color image forming mode (FC mode) as a second mode, a visible image (toner image) is formed at each image forming station in the order of black, yellow, magenta, and cyan. The visible images of the respective colors are sequentially superimposed and transferred onto the abutted intermediate transfer belt 15 to form a full-color toner image.

Since each of the image forming stations 10 has the same configuration except that the color of the toner to be handled is different, only the most downstream image forming station located at the left end of the drawing will be described with reference numerals here.

As illustrated in the drawing, the image forming station 10 includes a charger 2, a developing device 4, a primary transfer roller 5, and a drum cleaning device 7 disposed around a photoconductor drum 1 which is a latent image bearer.

The photoconductor drum 1 is a cylindrical photoconductor drum of having a diameter of 30 mm, and rotates at a peripheral speed of 50 mm/s to 300 mm/s. The roller-shaped charger 2 serving as a charging unit is pressed against the surface of the photoconductor drum 1, and is driven to rotate by the rotation of the photoconductor drum 1. A high-voltage power supply applies to the charger 2 a charging bias that is direct current (DC) or DC with alternating current (AC) superimposed thereon, and as a result the photoconductor drum 1 is uniformly charged to a surface potential such as −500 V.

Subsequently, exposure light from an exposure unit 3 serving as a latent image forming unit exposes image information on the photoconductor drum 1, thus forming an electrostatic latent image. This exposure step is performed by a laser beam scanner using, for example, a laser diode or a light emitting diode (LED). The surface potential of the exposed portion of the photoconductor drum 1 drops to, for example, −50 V.

The developing device 4 as a developing unit visualizes the electrostatic latent image on the photoconductor drum 1 as a toner image by a predetermined developing bias such as −200 V supplied from a high-voltage power supply. A primary transfer bias is applied to the primary transfer roller 5 by a high-voltage power supply, and a primary transfer electric field is formed at a primary transfer nip that is a contact position between the photoconductor drum 1 and the intermediate transfer belt 15.

In the toner image actualized on the photoconductor drum 1, the toner image on the photoconductor drum 1 is transferred onto the intermediate transfer belt 15 by a transfer electric field formed at the primary transfer nip when the toner image reaches the primary transfer nip. The transfer residual toner remaining on the photoconductor drum 1 without being primarily transferred to the intermediate transfer belt 15 is removed by a cleaning blade 6 abutting on a counter of the drum cleaning device 7. Then, the surface of each photoconductor drum 1 is neutralized by irradiating the surface of each photoconductor drum with neutralizing light by a neutralizing device 8, and the surface potential is initialized.

A transfer sheet P as a sheet is fed from a sheet feeding tray 22 located in a lower portion of a printer main body by a sheet feeding roller 23. The fed transfer sheet P is sent to a secondary transfer nip by a registration roller pair 24 in accordance with a timing at which the toner image portion on the surface of the intermediate transfer belt 15 reaches the secondary transfer nip between a secondary transfer roller 25 and a secondary-transfer backup roller 21. Then, the full-color toner image on the intermediate transfer belt 15 is collectively transferred onto the transfer sheet P by a secondary transfer electric field formed at the secondary transfer nip by a secondary transfer bias applied to the secondary transfer roller 25.

The residual toner on the intermediate transfer belt 15 that has not been transferred to the transfer sheet P is removed by a cleaning blade 31 of a belt cleaning device 32 above the intermediate transfer belt 15. The removed toner passes through a toner conveyance path communicating with the belt cleaning device 32, is conveyed to a waste toner container 33 disposed between the intermediate transfer belt 15 and the sheet feeding tray 22, and is collected.

The transfer sheet P onto which the full-color toner image has been transferred is conveyed to a fixing device 40, and the fixing device 40 fixes the toner image on the transfer sheet P onto the transfer sheet P by heat and pressure. Then, the transfer sheet P is ejected from an ejection port 41 to the outside of the apparatus.

In this way, the image forming process in the full-color image forming mode (may be referred to as “FC mode”) is completed.

Furthermore, the printer of the present embodiment includes a belt contact-separation mechanism that brings the intermediate transfer belt 15 into and out of contact with the photoconductor drums 1 of image forming stations (10C, 10M, 10Y) other than an image forming station (10Bk) of a Bk color. In the full-color image forming mode, the belt contact-separation mechanism is controlled such that the intermediate transfer belt 15 is brought into contact with each photoconductor drum 1. On the other hand, in a monochrome image forming mode (may be referred to as “BW mode”) as a first mode, the belt contact-separation mechanism is controlled such that the intermediate transfer belt 15 is separated from the photoconductor drum 1 of a color image forming station other than a Bk color image forming station. Specifically, the belt contact-separation mechanism includes an intermediate transfer contact-separation clutch, and the intermediate transfer belt 15 is contacted or separated by controlling the intermediate transfer contact-separation clutch. After completion of the printing operation, the intermediate transfer belt 15 is separated from the photoconductor drums 1 of the color image forming stations of the Y, M, and C colors and stands by.

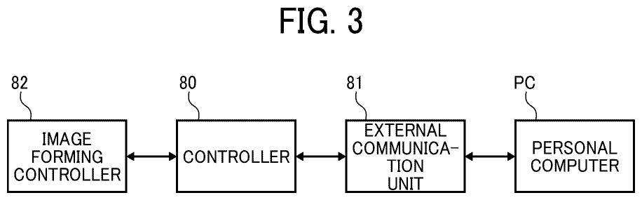

Among multiple image forming stations 10, an optical sensor unit 118 is disposed downstream in an intermediate transfer belt surface moving direction of the image forming station 10C for C disposed most downstream in the intermediate transfer belt surface moving direction. The optical sensor unit 118 faces a front surface of the intermediate transfer belt 15 with a predetermined gap interposed therebetween. In the optical sensor unit 118, three reflective photosensors, which are adhesion amount detection members, are arranged at a predetermined interval in a main scanning direction (width direction of the intermediate transfer belt). Light emitted from a light-emitting element is reflected by the front surface of the intermediate transfer belt 15 or the toner image on the belt, and the reflected light amount is detected by a light-receiving element. A controller 80 (see FIG. 3) detects the toner image on the intermediate transfer belt 15 and detects a toner adhesion amount per unit area of the toner image based on an output voltage value from the optical sensor unit 118.

In the present printer, an image adjustment control is performed for each certain number of sheets in order to stabilize the image quality against environmental change and over time.

When the number of sheets reaches a certain number, the printing operation is temporarily suspended, and the image adjustment control is performed. When the image adjustment control is performed, a gradation pattern including multiple toner patches having different image densities and a positional shift detection pattern are formed on the intermediate transfer belt 15. In these patterns, the toner adhesion amount and the formation position are detected by the optical sensor unit, image formation conditions such as a developing bias and a charging bias are adjusted based on the detected toner adhesion amount, and the exposure timing is adjusted based on the detected formation position.

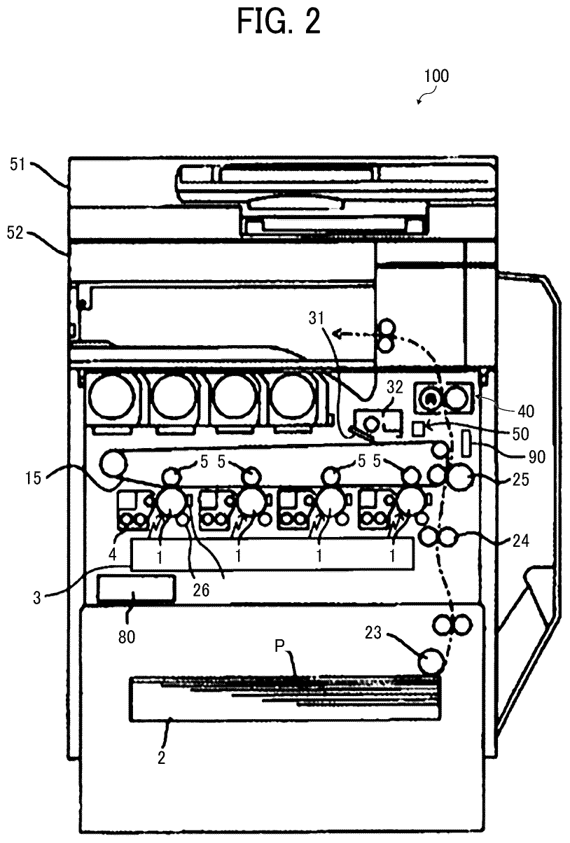

Note that the image forming apparatus may be an electrophotographic apparatus such as a copying machine having an image reading apparatus including a scanner unit 52 and an automatic document feeder (ADF) 51 in an upper portion illustrated in FIG. 2.

FIG. 3 is a control block diagram of the printer 100.

The controller 80 includes a central processing unit (CPU), a random-access memory (RAM), and a read-only member (ROM), and executes various programs to execute image processing and overall control of the printer. An external communication unit 81 for communicating with an external device such as a personal computer (PC), and an image forming controller 82 that controls each device, such as the fixing device 40 and the image forming stations 10 to form an image, are also connected to the controller 80.

A base component of the toner, silica or titanium oxide added to the toner, and other so-called external additives of the toner are transferred from the photoconductor drum 1 to the intermediate transfer belt 15. The external additives of the toner transferred to the intermediate transfer belt 15 adhere to the intermediate transfer belt 15, and filming (may be referred to as belt filming) may occur on the intermediate transfer belt 15. In addition, in a case where a lubricant application portion for applying a lubricant to the surface of the photoconductor drum 1 is provided, various components contained in the lubricant are also transferred from the photoconductor drum 1 to the intermediate transfer belt 15 in addition to the external additives of the toner. Then, the external additives of the toner and the lubricant may interact with each other, and belt filming may deteriorate. Furthermore, at the secondary transfer nip, paper powder may transfer from the transfer sheet P to the intermediate transfer belt 15, and adhere to the intermediate transfer belt 15, thereby causing paper powder filming.

Such belt filming is generated by adhesion of filming substances such as toner external additives such as silica and various components contained in the lubricant by external pressure (for example, contact pressure with the photoconductor drum 1) to the intermediate transfer belt 15. When belt filming occurs, once an all-solid image or a halftone image is output, no toner is placed on a portion corresponding to the belt filming, and an abnormal image such as a so-called white spot that appears white occurs.

In addition, when belt filming occurs, the glossiness of the belt decreases. Therefore, when belt filming occurs in a region facing the reflective photosensor of the optical sensor unit of the intermediate transfer belt 15, the output signal changes, and the adhesion amount of the toner image on the intermediate transfer belt cannot be satisfactorily detected. In addition, due to unevenness in a belt filming state, there is also a problem that the output of the reflective photosensor is not stable and image adjustment cannot be performed correctly. Furthermore, the cleaning performance of the cleaning blade 31 may deteriorate due to belt filming.

The belt filming is scraped off by toner staying at a contact portion (may be referred to as “cleaning portion”) between the cleaning blade 31 of the belt cleaning device 32 and the surface of the intermediate transfer belt 15, and can be removed from the surface of the intermediate transfer belt 15.

Specifically, belt filming on the surface of the intermediate transfer belt is scraped off by the unevenness of the surface of the toner staying at the cleaning portion and the pressure of the cleaning blade 31 applied to the toner.

Therefore, in order to reduce belt filming, a scraping toner pattern as a toner image pattern is formed on the intermediate transfer belt 15 at a predetermined timing. The scraping toner pattern is input to the cleaning blade 31 so that a sufficient amount of toner stays at the cleaning portion.

In addition, belt filming may deteriorate in the full-color image forming mode (FC mode) as compared with in the monochrome image forming mode (BW mode). The internal temperature tends to be higher in the FC mode than in the BW mode due to a higher fixing set temperature and an increase in the number of motors operated. As the internal temperature increases, the amount of stick-slip of the cleaning blade 31 increases, and belt filming may deteriorate. In addition, in the case of including the lubricant application portion that applies the lubricant to the surface of the photoconductor drum 1, in the FC mode, the amount of lubricant to be a component of the filming substances adhering to the intermediate transfer belt 15 is larger than that in the BW mode. Therefore, belt filming may further deteriorate in the FC mode as compared with in the BW mode.

Therefore, in the present embodiment, a required toner input amount, which is a cumulative value of a toner input amount as a filming indicator value, is calculated as follows, and the scraping toner pattern is formed when the required toner input amount exceeds a threshold.

The toner input amount as the filming indicator value is calculated as follows. That is, the image forming controller 82 acquires a travel distance of a color photoconductor drum mounted in the color image forming stations 10Y, 10M, and 10C in a predetermined period. The predetermined period may be set by the manufacturer of the image forming apparatus, service engineer, or the user. Based on the acquired distance information, the toner input amount is calculated by the following Formula 1.

$$Toner input amount = travel distance of photoconductor drum \times input amount conversion coefficient \qquad ( Formula 1 )$$

In the present embodiment, the toner input amount is calculated from the travel distance of the color photoconductor, but the toner input amount may be calculated based on the number of printed sheets at the time of execution of the FC mode.

The required toner input amount, which is the cumulative value of the toner input amount, is calculated by the following Formula 2.

$$Required toner input amount = toner input amount + previously required toner input amount \qquad ( Formula 2 )$$

When the required toner input amount exceeds a threshold, the image forming controller 82 forms a scraping toner pattern. After the scraping toner pattern is formed, a value obtained by subtracting the toner amount input to the cleaning blade 31 from the required toner input amount is updated as the required toner input amount.

The scraping toner pattern is formed before the start of printing, at the time of image adjustment, and after the end of printing. At these timings, the image forming controller 82 determines whether or not the required toner input amount exceeds the threshold, and when the required toner input amount exceeds the threshold, the scraping toner pattern is formed.

In the present embodiment, the toner input amount is calculated based on the travel distances of the color photoconductor drums 1Y, 1M, and 1C. Specifically, when the FC mode (full-color image forming mode) is started and the rotational driving of the color photoconductor is started, the measurement is started, and when the FC mode is ended and the rotational driving of the color photoconductor is stopped, the measurement is ended. After the measurement is completed, the toner input amount is calculated based on the travel distances of the color photoconductor drums 1Y, 1M, and 1C, and the required toner input amount is updated.

The color photoconductor drums 1Y, 1M, and 1C travel in the FC mode (full-color image forming mode). As described above, in the BW mode (monochrome image forming mode), the color photoconductor drums 1Y, 1M, and 1C are separated from the intermediate transfer belt 15, and image formation is performed with the color photoconductor kept stopped. Therefore, in the BW mode, the required toner input amount does not increase. As a result, when the FC mode is frequent, the required toner input amount exceeds the threshold at an early stage, and the scraping toner pattern is formed at an early timing. On the other hand, when the BW mode is frequent, the required toner input amount is delayed from exceeding the threshold, and the scraping toner pattern is formed at a later timing.

By forming the scraping toner pattern in this manner, the formation frequency of the scraping toner pattern increases under conditions where the operation ratio of the FC mode in a predetermined period is high and belt filming is more likely to deteriorate. As a result, the amount of toner input to the cleaning blade 31 of the belt cleaning device 32 in the predetermined period increases. Therefore, belt filming can be satisfactorily reduced.

On the other hand, under the condition that the operation ratio of the FC mode in the predetermined period is low and belt filming is reduced, the formation frequency of the scraping toner pattern decreases. As a result, the amount of toner input to the cleaning blade 31 of the belt cleaning device 32 in the predetermined period decreases, and wasteful toner consumption can be reduced.

However, in the formation control of the scraping toner pattern, reduction of wasteful toner consumption and reduction of belt filming are insufficient.

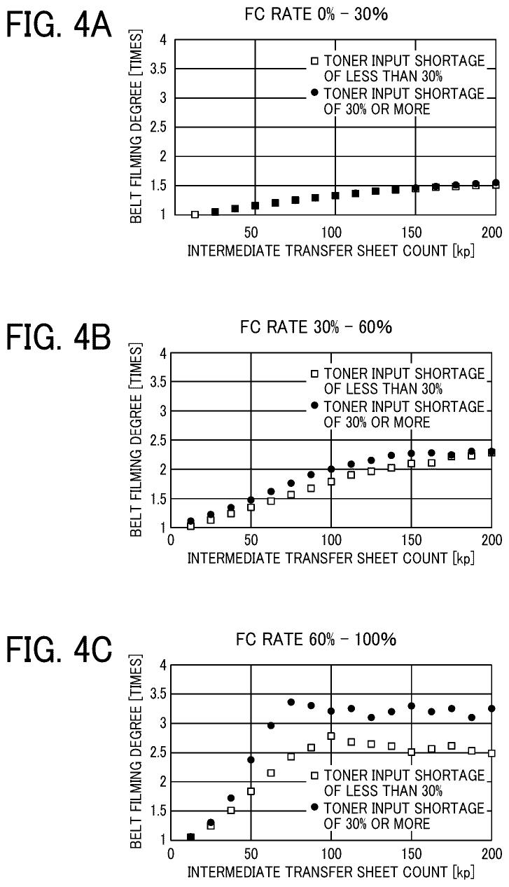

FIGS. 4A to 4C are graphs illustrating a relationship over time between a ratio of an input toner shortage and belt filming. FIG. 4A illustrates a case where the operation ratio (may be referred to as FC rate) in the FC mode (full-color image forming mode) is less than 30%. FIG. 4B illustrates a case where the FC rate is 30% or more and less than 60%, and FIG. 4C illustrates a case where the FC rate is 60% or more.

The FC rate can be calculated from the following Formula 3.

$$FC rate = ( number of printed sheets in FC mode / total number of printed sheets ) \times 100 [ \% ] \qquad ( Formula 3 )$$

Instead of the number of printed sheets, the FC rate may be calculated from the travel distance of the photoconductor drum 1 in the FC mode and the travel distance of the photoconductor drum 1 in the BW mode. Specifically, the FC rate is calculated by (travel distance of photoconductor drum 1 in FC mode/(travel distance of photoconductor drum 1 in FC mode+travel distance of photoconductor drum 1 in BW mode))×100%.

The degree of belt filming is obtained as follows. In the optical sensor unit 118, the current value of current flowing through the light-emitting element is adjusted to keep the output value from the reflective photosensor constant when the reflected light that is reflected from the surface of the intermediate transfer belt 15 is detected. The degree of belt filming is obtained based on the adjusted current value. Specifically, when belt filming deteriorates, reflected light from the belt surface weakens. Therefore, it is required to increase the current flowing through the light-emitting element in order to keep the output value from the reflective photosensor constant when the reflected light on the belt surface over time is detected. A value obtained by dividing the adjusted current value by a reference current value adjusted by the initial intermediate transfer belt 15 is obtained as a belt filming degree [times] (belt filming degree=(adjusted current value/reference current value)).

A toner input shortage rate is calculated by the following Formula 4.

$$Toner input shortage rate = ( required toner input amount / total toner input amount ) \times 100 [ \% ] \qquad ( Formula 4 )$$

The total toner input amount is a cumulative toner input amount from the start of use, and the toner input amount is calculated by Formula 1. At a filming degree measurement timing (current value adjustment timing), the numbers of times of printing in the FC mode and the BW mode, the number of printed sheets in the FC mode during one printing operation, and the number of printed sheets in the BW mode during one printing operation are adjusted such that the toner input shortage rate is less than 30%, or 30% or more. The toner input shortage rate of 100% is a state in which the scraping toner pattern is not formed even once until the time of calculation.

As can be seen from Formula 4, since the total toner input amount increases as the number of printed sheets increases, it is required to increase the required toner input amount by that amount in order to set the toner input shortage rate to 30% or more. The required toner input amount can be increased by reducing the opportunity of the formation timing of the scraping toner pattern until the number of printed sheets reaches that at the filming degree measurement timing (current value adjustment timing). Specifically, the number of printed sheets in the FC mode in one printing operation or the number of printed sheets in the BW mode in one printing operation is increased. Accordingly, the number of occurrences of the formation timings of the scraping toner pattern, namely, before the start of printing and after the end of printing, until the number of printed sheets reaches that at the filming degree measurement timing (current value adjustment timing) decreases. As a result, the formation frequency of the scraping toner pattern can be reduced, and the required toner input amount can be increased.

As illustrated in FIG. 4A, in a case where the FC rate is 0% or more and less than 30%, even when the toner input shortage rate is 30% or more, the belt filming degree is substantially the same as when the toner input amount shortage rate is less than 30%. When the FC rate is less than 30%, the formation frequency of the scraping toner pattern is lowered, and even when the toner input shortage rate is 30% or more, the belt filming degree [times] can be kept low at 1.5 or less. Thus, when the FC ratio is low at less than 30%, belt filming can be satisfactorily reduced even when the formation frequency of the scraping toner pattern is low.

On the other hand, as illustrated in FIG. 4C, when the FC rate is 60% or more, the difference in the degree of belt filming is large between a case where the toner input shortage rate is 30% or more and a case where the toner input shortage rate is less than 30%. In addition, it can be seen that the belt filming degree deteriorates as the number of printed sheets increases. When the FC rate is 60% or more, the toner input amount to the cleaning blade in the predetermined period is insufficient, and the filming removal on the intermediate transfer belt is not in time. Therefore, when the FC rate is 60% or more, it is required to frequently form the scraping toner pattern.

In a case where the input amount conversion coefficient which is an indicator value conversion coefficient is uniform, when the input amount conversion coefficient is set high so that belt filming does not deteriorate at an FC rate of 60% or more, the formation frequency of the toner scraping pattern is too high at an FC rate of less than 30%, and wasteful toner consumption occurs. On the other hand, when the input amount conversion coefficient is set low so that wasteful toner consumption does not occur at an FC rate of less than 30%, the formation frequency of the toner scraping pattern is too low at an FC rate of 60% or more, and belt filming deteriorates. Therefore, in the present embodiment, the input amount conversion coefficient described above is changed according to the FC rate. Features of the present embodiment will be described below as Example 1.

### Example 1

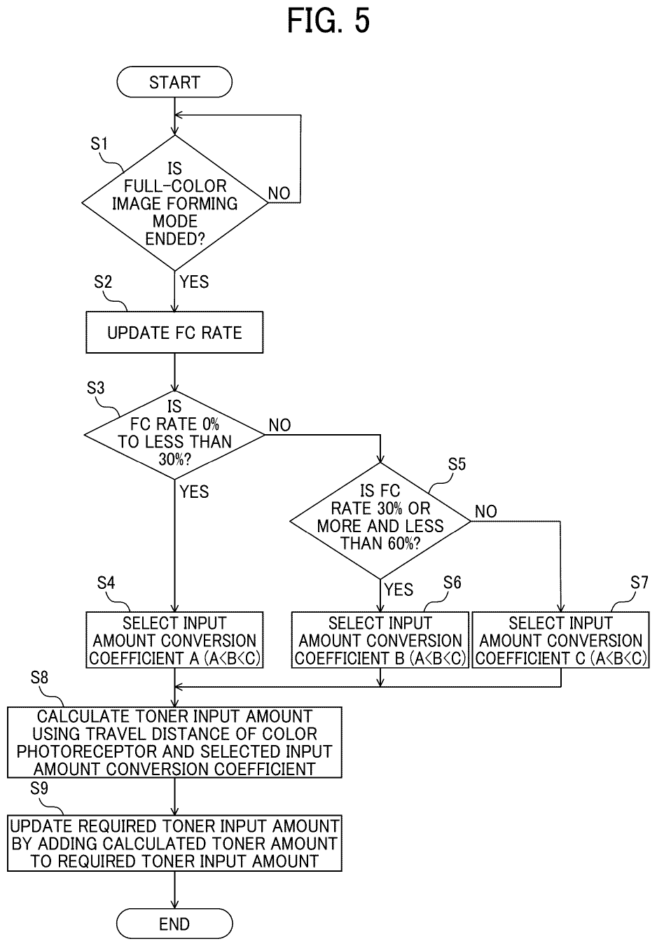

FIG. 5 is an input amount calculation flowchart according to Example 1.

As illustrated in FIG. 5, when the FC mode (full-color image forming mode) ends (Yes in S1), the FC rate is recalculated using the travel distance of the color photoconductor and the number of printed sheets in the current FC mode, and the FC rate is updated (S2).

When the updated FC rate is less than 30%, an input amount conversion coefficient A is selected (S3).

On the other hand, when the FC rate is 30% or more and less than 60% (No in S2, Yes in S4), an input amount conversion coefficient B having a larger value than the input amount conversion coefficient A when the FC rate is less than 30% is selected (S5). When the FC rate is 60% or more (No in S2 and No in S4), an input amount conversion coefficient C having a larger value than the input amount conversion coefficient B when the FC rate is 30% or more and less than 60% is selected (S6).

Then, a toner input amount is calculated from the travel distance of the color photoconductor and the selected input amount conversion coefficient (S7), the calculated toner amount is added to a required toner input amount stored in a nonvolatile memory such as a hard disk drive (HDD) or a ROM, and the required toner input amount is updated (S8).

By setting the input amount conversion coefficient when the FC rate is less than 30% lower than that when the FC rate is 30% or more and less than 60%, the toner input amount calculated when the FC rate is less than 30% is smaller than that when the FC rate is 30% or more and less than 60% even when the travel distances of the color photoconductor are the same. As a result, in the case of the FC rate of less than 30%, the travel distance of the color photoconductor until the required toner input amount reaches the threshold is increased as compared with the case of the FC rate of 30% or more and less than 60%, and the formation frequency of the scraping toner pattern can be reduced. As a result, wasteful toner consumption can be reduced as compared with a case where the input amount conversion coefficient when the FC rate is less than 30% is the same as that when the FC rate is 30% or more and less than 60%.

In addition, by making the input amount conversion coefficient when the FC rate is 60% or more larger than that when the FC rate is 30% or more and less than 60%, the toner input amount when the FC rate is 60% or more is larger than that when the FC rate is 30% or more and less than 60% even when the travel distances of the color photoconductor are the same. As a result, in the case of the FC rate of 60% or more, the travel distance of the color photoconductor until the required toner input amount reaches the threshold is reduced as compared with the case of the FC rate of 30% or more and less than 60%, and the formation frequency of the scraping toner pattern can be increased. As a result, deterioration of belt filming can be reduced as compared with the case where the input amount conversion coefficient when the FC rate is 60% or more is the same as that when the FC rate is 30% or more and less than 60%.

As described above, in Example 1, the toner input amount is calculated only in the FC mode, the formation frequency of the scraping toner pattern when the FC rate is high is increased, and the input amount conversion coefficient is changed according to the FC rate. As a result, the toner input amount to the cleaning blade in the predetermined period can be controlled more finely according to the FC rate. Therefore, wasteful toner consumption can be favorably reduced, and belt filming can be reduced.

Next, Example 2 is described.

### Example 2

In Example 2, when the required toner input amount exceeds the threshold, it is determined whether to skip the formation of the scraping toner pattern. Then, the formation frequency of the scraping toner pattern is changed according to the FC rate by changing the number of times of skipping the formation of the scraping toner pattern according to the FC rate or the like.

As described above, in the present embodiment, the formation timing of the scraping toner pattern is set to before the start of printing, at the time of image adjustment, and after the end of printing.

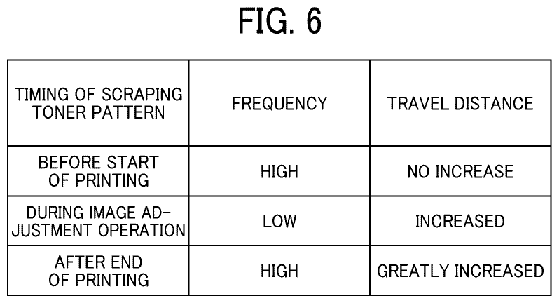

FIG. 6 is a table illustrating a relationship among a formation timing of a scraping toner pattern, a frequency of each formation timing, and a travel distance of an image formation related member.

The timing before the start of printing is a timing from after the image signal is input to the printer until before the toner image is secondarily transferred onto the transfer sheet P. When an image signal is input to the printer, a predetermined ramp-up operation is performed before image formation of image data input from a personal computer (PC) is started. The ramp-up operation raises the temperature in the fixing device 40 from a standby temperature to a fixing temperature, drives the motors of the respective units, applies a bias to the respective members, and confirms whether the respective members operate normally.

Before the application is started, the scraping toner pattern is formed at the time of the ramp-up operation. As a result, during a period from when the scraping toner is formed into the pattern to when the scraping pattern is input to the cleaning blade 31 of the belt cleaning device 32, the travel distance of each member of the image forming station such as the photoconductor drum or the image formation related member such as the intermediate transfer belt hardly increases. Therefore, as illustrated in FIG. 6, the evaluation of the travel distance before the start of printing is “no increase”. Further, since the printing operation is frequently performed, as illustrated in FIG. 6, the evaluation of the formation frequency of the scraping toner pattern before the start of printing is “high”.

Before the start of printing, a scraping toner pattern is formed in the Bk color image forming station among the image forming stations of four colors. This is because, in the standby state, the intermediate transfer belt 15 is separated from the color photoconductors (1Y, 1M, 1C). Therefore, by forming the scraping toner pattern in the Bk color image forming station, in a state where the intermediate transfer belt 15 is not in contact with the color photoconductor drum 1, the scraping pattern can be primarily transferred to the intermediate transfer belt 15, and an increase in the travel distance of the image formation related member can be minimized.

An image adjustment operation is performed by suspending the printing operation when the number of sheets reaches a certain number, and the scraping toner pattern is formed before or after the formation of the gradation pattern and the positional shift detection pattern described above. Therefore, the travel distance of the image formation related member is increased by the formation of the scraping toner pattern. Therefore, as illustrated in FIG. 6, the evaluation of the travel distance at the time of image adjustment is “increased”.

The image adjustment operation is performed when the number of sheets reaches a certain number, and the formation frequency of the scraping toner pattern in the image adjustment operation is lower than before the start of printing or after the end of printing unless the number of printed sheets in one printing operation is large. Therefore, as illustrated in FIG. 6, the evaluation of the formation frequency of the scraping toner pattern in the image adjustment operation is “low”.

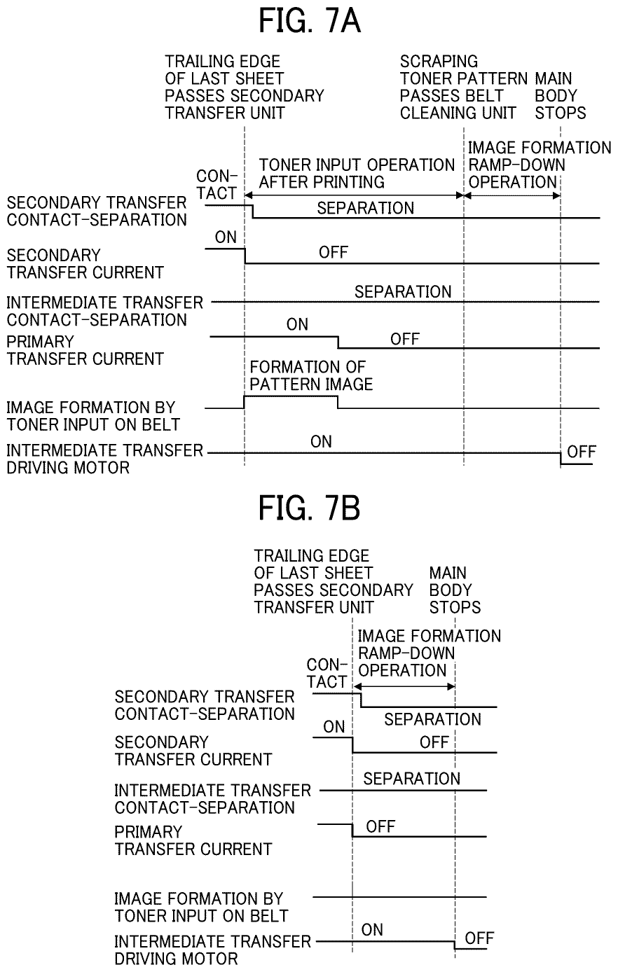

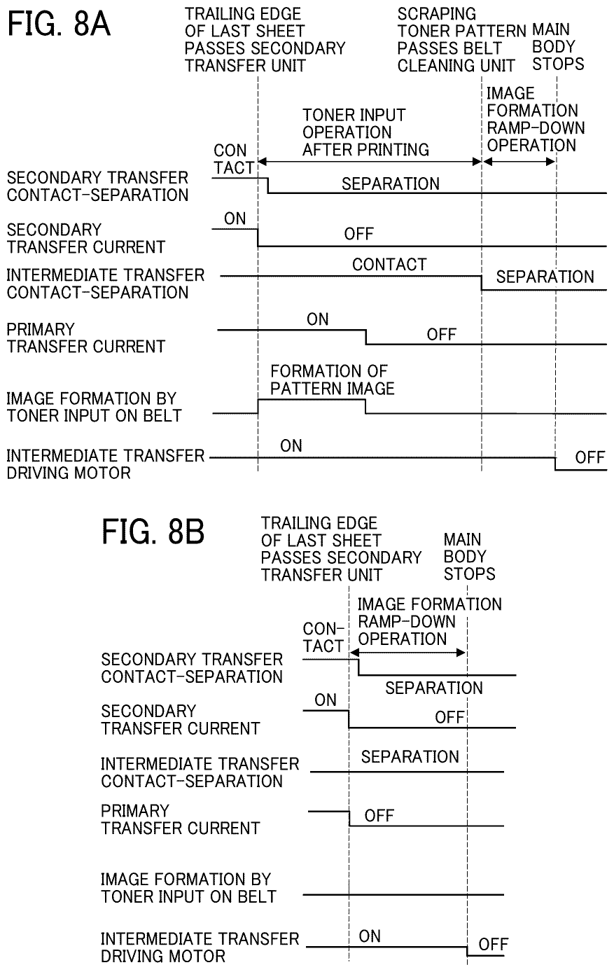

FIGS. 7A and 7B are diagrams illustrating an operation after the end of printing in the BW mode, in which FIG. 7A illustrates a case where the scraping toner pattern is formed after printing, and FIG. 7B illustrates a case where there is no input of the scraping toner pattern. FIGS. 8A and 8B are diagrams illustrating an operation after the end of printing in the full-color image forming mode, in which FIG. 8A illustrates a case where the scraping toner pattern is formed after the end of printing, and FIG. 8B illustrates a case where there is no input of the scraping toner pattern.

“After the end of printing” is the timing after the toner image of the last page has been transferred onto the transfer sheet.

As illustrated in FIGS. 7A and 7B, in the BW mode, after the end of printing after the final sheet passes through the secondary transfer nip, the output of a secondary transfer current is stopped to separate the secondary transfer roller 25. As illustrated in FIG. 7A, in the case of forming the scraping toner pattern, after the end of printing, image formation of the scraping toner pattern is started to primarily transfer the scraping toner pattern to the intermediate transfer belt 15. After the scraping toner pattern is primarily transferred to the intermediate transfer belt 15, the output of a primary transfer current (primary transfer bias) is stopped. Then, the intermediate transfer belt 15 and the members of the image forming station are driven until the rear end of the scraping toner pattern enters the cleaning blade 31 of the belt cleaning device 32. After the rear end of the scraping toner pattern enters the cleaning blade 31, or, in parallel, before the entry, the image formation ramp-down operation is executed, and the main body stops.

On the other hand, when the scraping toner pattern is not formed, as illustrated in FIG. 7B, the secondary transfer roller is separated, and at the same time, the image formation ramp-down operation is performed, and the main body stops.

In the BW mode, as can be seen from the comparison between FIGS. 7A and 7B, by forming the scraping toner pattern, the travel distance of each member such as the photoconductor drum of the Bk image forming station and the image formation related member such as the intermediate transfer belt is greatly increased.

As illustrated in FIGS. 8A and 8B, in the FC mode, after the rear end of the scraping toner pattern enters the cleaning blade 31 of the belt cleaning device 32, the intermediate transfer belt 15 is separated from the color photoconductor drum, and at the same time, the image formation ramp-down operation is performed. When the driving of the color photoconductor is stopped, the toner input amount is calculated based on the travel distance of the color photoconductor. Then, the toner input amount is added to the required toner input amount stored in the nonvolatile memory, and the required toner input amount is updated. In addition, the calculated toner input amount is added to a total toner input amount stored in the nonvolatile memory to update the total toner input amount. Then, the toner input shortage rate is calculated from the calculated required toner input amount and the updated total toner input amount, and the toner input shortage rate stored in the nonvolatile memory is replaced with the calculated toner input shortage rate.

The scraping toner pattern after the end of printing in the FC mode may be formed in the image forming station of the Bk color or may be formed in an image forming station of a color other than the Bk color. The scraping toner pattern is preferably formed at an image forming station (in the present embodiment, the C color image forming station, see FIG. 1) most downstream in the surface moving direction of the intermediate transfer belt 15 among the multiple image forming stations. This can shorten the travel distance of the intermediate transfer belt 15 from when the scraping toner pattern is primarily transferred to the intermediate transfer belt 15 to when the scraping toner pattern enters the cleaning blade 31. As a result, the increase of the travel distance of the image formation related member can be minimized.

In addition, the toner amount of the scraping toner pattern can be increased by forming the scraping toner pattern formed after the end of printing in the full-color image forming mode by multiple image forming stations. When the scraping toner patterns formed by the multiple image forming stations are transferred to different positions of the intermediate transfer belt 15, the scraping toner patterns of the intermediate transfer belt 15 become long. Therefore, it is preferable that when the scraping toner patterns are formed by the multiple image forming stations, the scraping toner patterns formed by the image forming stations are primarily transferred so as to overlap each other on the intermediate transfer belt.

As can be seen from the comparison between FIGS. 8A and 8B, also in the FC mode, the travel distance of each member such as the photoconductor drum of the image forming stations of Y, M, C, and Bk and the image formation related member such as the intermediate transfer belt 15 is greatly increased by the formation of the scraping toner pattern. Therefore, as illustrated in FIG. 6, the evaluation of the travel distance before the start of printing is “greatly increased”. Further, since the printing operation is frequently performed, as illustrated in FIG. 6, the evaluation of the formation frequency of the scraping toner pattern after the end of printing is “high”.

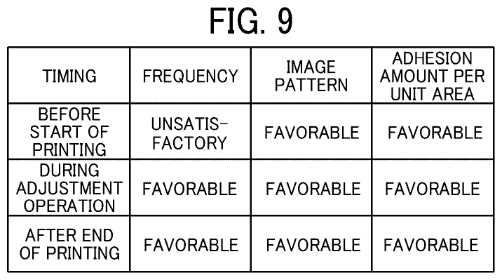

FIG. 9 illustrates evaluation by adjustment of a toner input amount to the cleaning blade of the belt cleaning device 32 in a predetermined period for each formation timing of the scraping toner pattern. As illustrated in FIG. 9, the frequency adjustment of scraping toner pattern formation before the start of printing is evaluated as unsatisfactory for the following reasons. That is, as described above, before the start of printing, the travel distance of the image formation related member is not increased by the formation of the scraping toner pattern, and the effect of the frequency reduction is only the reduction of the wasteful consumption of the toner.

The increase or decrease in the travel distance of the image formation related member due to the change in the scraping toner pattern is the same at each formation timing, and thus, is evaluated as favorable at each formation timing. In addition, since there is no increase or decrease in the travel distance of the image formation related member due to the change in the adhesion amount of the scraping toner pattern, evaluation is favorable at each formation timing.

As described above, at the time of the image adjustment operation or the timing after the end of printing, the travel distance of each member of the image forming station and the image formation related member such as the intermediate transfer belt is increased, and their service life is shortened. Therefore, in Example 2, the formation frequency of the scraping toner pattern at the time of the image adjustment operation or at the timing after the end of printing is reduced as the FC rate is lower. As a result, in Example 2, wasteful toner consumption when the FC rate is low is reduced, and the increases of the travel distance of the components of the image forming stations and the image formation related members, such as the intermediate transfer belt, are minimized.

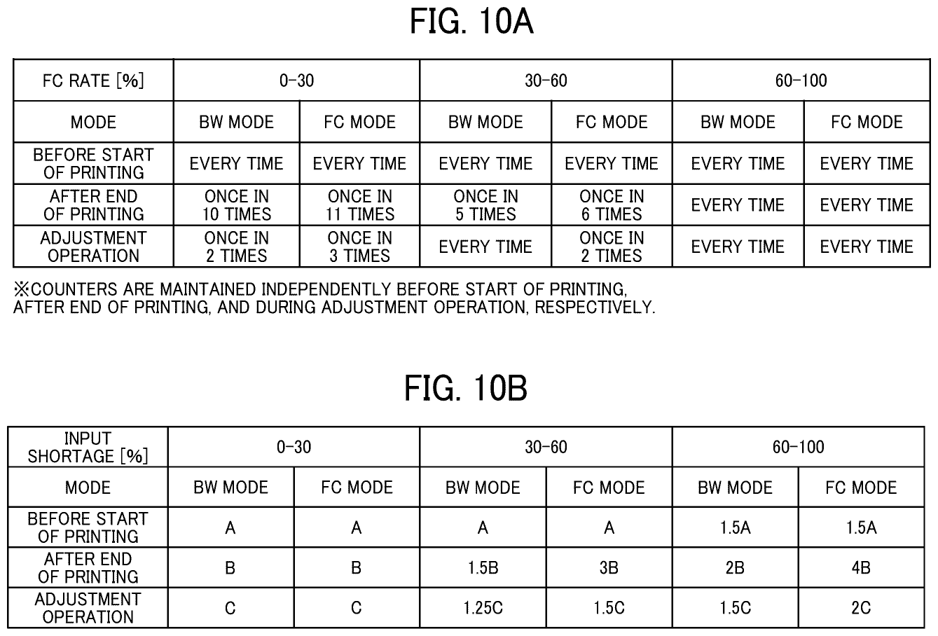

FIG. 10A is a table illustrating a formation frequency of the scraping toner pattern at each formation timing in Example 2, and FIG. 10B is a table illustrating a toner amount of the scraping toner pattern at each formation timing in Example 2. The “BW mode” in the image adjustment operation is a case where the image adjustment operation is performed while suspending the printing operation in the BW mode, and the “FC mode” in the image adjustment operation is a case where the image adjustment operation is performed while suspending the printing operation in the FC mode.

“Every time” illustrated in FIG. 10A indicates that a scraping toner pattern is formed every time when the required toner input amount exceeds the threshold. In addition, the FC rate of 0% to 30%, the BW mode, and “once in 10 times” after printing illustrated in FIG. 10A mean that even when the required toner input amount exceeds the threshold at the timing after the end of printing, the formation of the scraping toner pattern is skipped for nine times, and the scraping toner pattern is formed at the tenth time.

Further, A to C in FIG. 10B indicate the toner amounts of the scraping toner patterns formed at each timing at which the toner input shortage rate is less than 30%, which are calculated by the above Formula 4, and the values of A, B, and C are different from each other. The toner amount of the scraping toner pattern can be increased, for example, by increasing the image density (increasing the adhesion amount) as compared with the scraping toner pattern at a toner input shortage rate of less than 30%. In addition, the toner amount of the scraping toner pattern can be increased by making the length in a sub-scanning direction (the surface moving direction of the intermediate transfer belt) longer than that of the scraping toner pattern when the toner input shortage rate is less than 30%.

In addition, when a large amount of toner is input to the cleaning blade 31 of the belt cleaning device 32 at one time, a cleaning failure may occur. Therefore, the scraping toner pattern may include multiple toner patches, and the number of toner patches may be increased to increase the toner amount of the scraping toner pattern.

A data table illustrated in FIG. 10A and a data table illustrated in FIG. 10B are stored in a nonvolatile memory such as a ROM or an HDD of the printer 100. When the formation timing of the scraping toner pattern is reached, the data table illustrated in FIG. 10A and the data table illustrated in FIG. 10B are read out from the nonvolatile memory. Then, the number of times of skipping the formation of the scraping toner pattern and the toner amount of the scraping toner pattern are specified based on the FC rate, the print mode (FC mode, BW mode), the formation timing of the scraping toner pattern (before the start of printing, at the time of image adjustment operation, and after the end of printing), and the toner input shortage rate.

As illustrated in FIG. 10A, in Example 2, the scraping toner pattern is formed when the required toner input amount uniformly exceeds the threshold regardless of the FC rate before the start of printing. As described above with reference to FIG. 6, the travel distance of the image formation related member hardly increases before the start of printing. Therefore, by actively forming the scraping toner pattern at the timing before the start of printing, the formation frequency of the scraping toner pattern after the end of printing can be correspondingly reduced (the number of times of skipping can be increased).

This can reduce wasteful toner consumption and satisfactorily reduce belt filming while reducing increase of the travel distance of the image formation related member due to formation of the scraping toner pattern. The formation of the scraping toner pattern may be skipped multiple times before the start of printing.

When the FC rate is 60% or more, the scraping toner pattern is formed when the required toner input amount exceeds the threshold at the formation timing of all the scraping toner patterns. As a result, the input frequency of the scraping toner pattern increases. As a result, the toner amount input to the cleaning blade 31 in the predetermined period can be increased, and deterioration of belt filming can be favorably reduced.

As illustrated in FIG. 10A, the FC mode has a larger number of times of skipping the formation of the scraping toner pattern at the timing of the adjustment operation after the end of printing respectively at the FC rate of less than 30%, and the FC rate of 30% or more and less than 60%. As a result, the formation frequency of the scraping toner pattern in the FC mode is lower than that in the BW mode. This is because, in the FC mode, in addition to the Bk color, the travel distance of each member of the image forming stations of the colors (Y, M, C) also increases. Therefore, after the end of printing, the number of times of skipping the formation of the scraping toner pattern at the timing during the adjustment operation is larger in the FC mode, and the formation frequency of the scraping toner pattern in the FC mode is made lower than that in the BW mode. This can extend the service life of each member of the image forming stations of the colors (Y, M, C).

As illustrated in FIG. 10B, in Example 2, the toner amount of the scraping toner pattern is changed based on the toner input shortage rate. As a result, for example, when a printing operation with a large number of printed sheets frequently occurs and the toner input shortage rate increases, the toner amount of the scraping toner pattern can be increased to increase the toner amount input to the cleaning blade 31 of the belt cleaning device 32. By increasing the toner amount input to the cleaning blade 31, the scraping amount of belt filming can be increased, and deterioration of belt filming can be favorably reduced. On the other hand, when the toner input shortage rate is low and the toner input to the cleaning blade 31 is sufficiently in time for belt filming, the toner amount of the scraping toner pattern can be reduced. Accordingly, wasteful toner consumption can be reduced.

As described above, in Example 2, by combining the formation frequency of the scraping toner pattern and the toner amount of the scraping toner pattern, the toner input amount to the cleaning blade 31 in the predetermined period can be set to an appropriate amount according to the belt filming state. As a result, wasteful consumption of toner can be favorably reduced, and belt filming can be reduced.

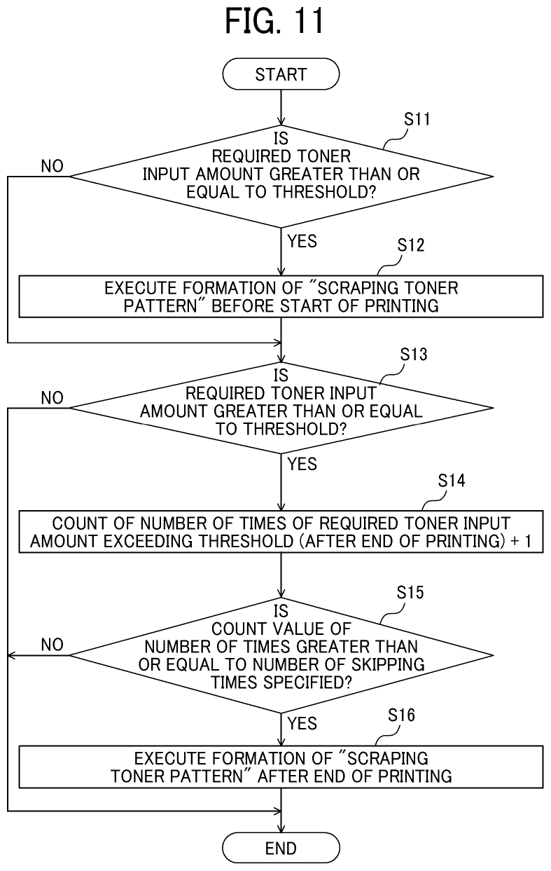

FIG. 11 is a flowchart for determining formation of the scraping toner pattern during the printing operation in Example 2.

When an image signal is input to the printer, a required toner input amount stored in a nonvolatile memory such as a ROM or an HDD is read. When the required toner input amount exceeds the threshold (Yes in S11), the scraping toner pattern is formed before the start of printing (S12).

In the nonvolatile memory such as a ROM or an HDD of the printer 100, a data table illustrated in FIG. 10B and a toner input shortage rate are stored. In the case of forming the scraping toner pattern before the start of printing, the data table illustrated in FIG. 10B and the toner input shortage rate are read from the nonvolatile memory. Then, the toner amount of the scraping toner pattern satisfying the conditions of the toner input shortage rate, the current print mode (FC mode or BW mode), and before the start of printing is specified from the data table illustrated in FIG. 10B. Then, the image formation of the scraping toner pattern is performed so as to have the specified toner amount.

After the scraping toner pattern is formed, the required toner input amount is updated by subtracting the toner amount input to the cleaning blade 31 of the belt cleaning device 32 this time (the toner amount of the scraping toner pattern) from the required toner input amount before the scraping toner pattern is formed. In addition, the toner input shortage rate is calculated using the updated required toner input amount, and the toner input shortage rate stored in the nonvolatile memory is replaced with the calculated toner input shortage rate.

Next, when the printing operation is completed, the required toner input amount stored in the nonvolatile memory is read, and it is determined whether the required toner input amount exceeds the threshold (S13). When the required toner input amount exceeds the threshold, the count value of the number of times of exceeding the threshold stored in the nonvolatile memory (the number of times of skipping the formation of the scraping toner pattern) is increased by 1 (S14). Next, the data table illustrated in FIG. 10A stored in the nonvolatile memory such as a ROM or an HDD of the printer 100 is read. Then, from the data table illustrated in FIG. 10A, the number of skipping times, which satisfies the conditions of the current FC rate, the current print mode (FC mode or BW mode), and after the end of printing, is specified.

When the count value of the number of times this time is greater than or equal to the specified number of skipping times (Yes in S15), the scraping toner pattern is formed after the end of printing. First, the data table illustrated in FIG. 10B and the toner input shortage rate are read from the nonvolatile memory. Next, the toner amount of the scraping toner pattern satisfying the conditions of the toner input shortage rate, the current print mode (FC mode or BW mode), and before the start of printing is specified from the data table illustrated in FIG. 10B. Then, the image formation of the scraping toner pattern after the end of printing is performed in a manner that the specified toner amount is obtained (S16).

After the scraping toner pattern is formed, the required toner input amount is updated by subtracting the toner amount input to the cleaning blade 31 of the belt cleaning device 32 this time (the toner amount of the scraping toner pattern) from the required toner input amount before the scraping toner pattern is formed. In addition, the toner input shortage rate is recalculated using the updated required toner input amount, and the toner input shortage rate stored in the nonvolatile memory is replaced with the recalculated toner input shortage rate.

Also at the timing of the image adjustment operation, after the count value of the number of times of exceeding the threshold is increased by 1, the number of skipping times that satisfies the conditions of the current FC rate and the suspended print mode (FC mode or BW mode) is specified from the data table illustrated in FIG. 10A. When the count value of the number of times is greater than or equal to the specified number of skipping times, the scraping toner pattern is formed in the image adjustment operation. Also in this case, the toner amount is specified from the toner input shortage rate and the data table illustrated in FIG. 10B, and the image formation of the scraping toner pattern is performed to result in the specified toner amount.

In Example 2, as illustrated in FIG. 10A, before the start of printing, when the required toner input amount exceeds the threshold at all FC rates, the scraping toner pattern is formed every time.

Therefore, in the flow illustrated in FIG. 11, it is not determined whether or not to skip the formation of the scraping toner pattern. However, depending on the FC rate, when the formation of the scraping toner pattern is skipped even before the start of printing, steps S14 to S16 illustrated in FIG. 11 are performed even before the start of printing.

In Example 2, similarly to Example 1, the input amount conversion coefficient used at the time of calculating the toner input amount may be changed according to the FC rate. As a result, when the FC rate is low, the travel distance of the color photoconductor until the required toner input amount exceeds the threshold can be increased, the formation frequency of the scraping toner pattern can be reduced, and wasteful consumption of toner can be reduced. On the other hand, when the FC rate is high, the travel distance of the color photoconductor until the required toner input amount exceeds the threshold can be reduced, the formation frequency of the scraping toner pattern can be increased, and deterioration of belt filming can be reduced.

Also in Example 1, the toner amount of the scraping toner pattern may be changed based on the input toner shortage rate. Specifically, the data table illustrated in FIG. 10B is stored in the nonvolatile memory, and the data table illustrated in FIG. 10B and the toner input shortage rate are read from the nonvolatile memory at the time of forming the scraping toner pattern. Then, the toner amount matching the toner input shortage rate, the current print mode (FC mode or BW mode), and the formation timing of the scraping toner pattern is specified from the data table illustrated in FIG. 10B. The image formation of the scraping toner pattern is performed so as to have the specified toner amount. As a result, also in Example 1, when the toner input shortage rate increases due to the printing operation with a large number of printed sheets, the toner amount input to the cleaning blade 31 of the belt cleaning device 32 can be increased. As a result, the scraping amount of belt filming increases, and deterioration of belt filming can be satisfactorily reduced.

As illustrated in FIGS. 4A to 4C, when the FC rate is less than 30%, there is almost no difference in the belt filming degree between the case when the toner input shortage rate is 30% or more and the case when the toner input shortage rate is less than 30%. On the other hand, as the FC rate increases, the difference in the belt filming degree between the case when the toner input shortage rate is 30% or more and the case when the toner input shortage rate is less than 30% increases. Therefore, the toner amount corresponding to each toner input shortage rate may be changed among the case when the FC rate is less than 30%, the case when the FC rate is 30% or more and less than 60%, and the case when the FC rate is 60% or more. For example, when the FC rate is less than 30%, there is not much difference in the belt filming degree due to the toner input shortage rate, and thus, the toner amount is made uniform regardless of the input shortage rate. As a result, wasteful toner consumption is further reduced.

On the other hand, when the FC rate is 60% or more, as can be seen from FIG. 4C, the belt filming degree when the input shortage rate is high is worse than when the toner input shortage rate is low. Therefore, the toner amount in a case where the toner input shortage rate is high is made larger than that in a case where the FC rate is 30% or more and less than 60%, and the toner input shortage rate is recovered as quickly as possible. As a result, deterioration of filming can be satisfactorily reduced.

Embodiments of the present disclosure have been described above, but the present disclosure is not limited to such particular embodiments. Unless otherwise limited in the above description, various modifications and alterations may be made without departing from the scope of the gist of the present disclosure in the claims.

The embodiments described above are merely examples, and the various aspects of the present disclosure attain respective effects as follows.

### Aspect 1

According to Aspect 1, an image forming apparatus includes: an image bearer such as the intermediate transfer belt 15 that bears a toner image; image forming units such as multiple image forming stations that form the toner image on the image bearer; a transfer member such as the secondary transfer roller 25 that transfers the toner image on the image bearer onto a sheet such as transfer sheet; a cleaning member such as the cleaning blade 31 that cleans a surface of the image bearer; and control circuitry such as the image forming controller 82 that controls formation, on the image bearer, of a toner image pattern such as a scraping toner pattern to be input to the cleaning member, the image forming apparatus having a first mode, such as the BW mode (monochrome image forming mode), in which the toner image is formed on the image bearer by one image forming unit, and a second mode, such as the FC mode (full-color image forming mode), in which the toner image is formed on the image bearer by multiple image forming units, the control circuitry controlling formation of the toner image pattern based on an indicator value, such as a toner input amount, which is calculated by multiplying either a travel distance of a latent image bearer such as a photoconductor drum included in the image forming units in the second mode or a number of printed sheets in the second mode by an indicator value conversion coefficient such as an input amount conversion coefficient, and changes the indicator value conversion coefficient based on an operation ratio of the second mode during a predetermined period, such as the FC rate.

In the related art, as described above, by calculating the indicator value by setting the indicator value conversion coefficient of the second mode such as the FC mode (full-color image forming mode) to be higher than the indicator value conversion coefficient of the first mode such as the BW mode (monochrome image forming mode), the formation frequency of the toner image pattern increases when the operation ratio of the second mode is high, and the formation frequency of the toner image pattern can be lowered when the operation ratio of the first mode is high. However, since each indicator value conversion coefficient is uniformly set regardless of the operation ratios of the first mode and the second mode, the indicator value may be excessively calculated with respect to an actual filming amount.

In contrast, according to Aspect 1, by also changing the indicator value conversion coefficient in accordance with the operation ratio, as compared with changing the indicator value conversion coefficient solely based on whether the first mode or the second mode is used, an indicator value that more closely corresponds to actual filming of the image bearer can be calculated. As a result, as compared with the related art, an optimum toner amount which more closely corresponds to the filming of the image bearer can be input, thereby reducing wasteful toner consumption.

According to Aspect 1, the indicator value is calculated by multiplying either the travel distance of the latent image bearer such as the photoconductor drum included in the image forming units in the second mode or the number of printed sheets in the second mode by the indicator value conversion coefficient, and the indicator value is not calculated in the first mode. As a result, the formation frequency of the toner image pattern increases when the operation ratio of the second mode is high, and the formation frequency of the toner image pattern can be lowered when the operation ratio of the first mode is high.

### Aspect 2

According to Aspect 2, in the image forming apparatus of Aspect 1, the control circuitry such as the image forming controller 82, in a case that a required toner input amount, which is calculated based on the indicator value such as the toner input amount and a toner amount of the toner image pattern such as the scraping toner pattern input to the cleaning member such as the cleaning blade 31, exceeds a threshold, determines whether to form the toner image pattern or to skip the formation of the toner image pattern, and sets a number of times of skipping the formation of the toner image pattern based on the operation ratio.

Accordingly, as described in Example 2, in accordance with the operation ratio of the second mode, such as the FC rate, even when a cumulative value of the indicator value, such as the required toner input amount, exceeds the threshold, by skipping the formation of the toner image pattern such as the scraping toner pattern multiple times, the formation frequency of the toner image pattern can be changed in accordance with the operation ratio of the second mode, such as the FC rate. As a result, when the operation ratio of the second mode is low and the progress speed of belt filming is slow, by increasing the number of times of skipping the formation of the scraping toner image, the formation frequency of a toner image forming pattern can be reduced, and wasteful toner consumption can be reduced. On the other hand, when the operation ratio of the second mode is high and the progress speed of belt filming is fast, by reducing the number of times of skipping the formation of the scraping toner image, the formation frequency of the toner image forming pattern can be increased, and belt filming can be satisfactorily reduced.

### Aspect 3

According to Aspect 3, an image forming apparatus includes: an image bearer such as the intermediate transfer belt 15 that bears a toner image; image forming units such as multiple image forming stations that form the toner image on the image bearer; a transfer member such as the secondary transfer roller 25 that transfers the toner image on the image bearer onto a sheet such as transfer sheet; a cleaning member such as the cleaning blade 31 that cleans a surface of the image bearer; and control circuitry such as the image forming controller 82 that controls formation, on the image bearer, of a toner image pattern such as a scraping toner pattern to be input to the cleaning member, the image forming apparatus having a first mode, such as the monochrome image forming mode (BW mode), in which the toner image is formed on the image bearer by one image forming unit, and a second mode, such as the full-color image forming mode (FC mode), in which the toner image is formed on the image bearer by multiple image forming units, the control circuitry, in a case that a required toner input amount, calculated based on an indicator value such as a toner input amount which is calculated by multiplying an indicator value conversion coefficient such as an input amount conversion coefficient by either a travel distance of a latent image bearer such as the photoconductor drum included in the image forming units in the second mode or a number of printed sheets in the second mode, and based on a toner amount of the toner image pattern input to the cleaning member, exceeds a threshold, determining whether to form the toner image pattern or to skip the formation of the toner image pattern, and based on an operation ratio of the second mode during a predetermined period, setting a number of times of skipping the formation of the toner image pattern.

Accordingly, as described in Example 2, in accordance with the operation ratio of the second mode, such as the FC rate, even when a cumulative value of the indicator value, such as the required toner input amount, exceeds the threshold, by skipping the formation of the toner image pattern such as the scraping toner pattern multiple times, the formation frequency of the toner image pattern can be changed in accordance with the operation ratio of the second mode, such as the FC rate. As a result, when the cumulative value of the indicator value exceeds the threshold, the toner amount can be input to the cleaning member such as the cleaning blade 31 at the optimum timing according to the filming of the image bearer such as the intermediate transfer belt 15 as compared with the case where the toner image pattern is uniformly formed regardless of the operation ratio of the second mode, and wasteful toner consumption can be reduced.

### Aspect 4

According to Aspect 4, in the image forming apparatus of Aspect 2 or 3, the toner image pattern such as the scraping toner pattern is formed at timings before a start of a printing operation for forming the toner image on the sheets, after an end of the printing operation, and in image adjustment, and, at the timings after the end of the printing operation and in the image adjustment, the control circuitry determines whether to form the toner image pattern or to skip the formation of the toner image pattern.

Accordingly, as described in Example 2, when the toner image pattern such as the scraping toner pattern is formed at the timings after the end of the printing operation, and in image adjustment, the travel distance of each member of the image forming unit such as the latent image bearer like the photoconductor drum or the image bearer such as the intermediate transfer belt 15 may be increased, and their service life may be shortened. On the other hand, before the start of the printing operation, when the operation is confirmed by rotating each member in the ramp-up operation, the toner image pattern can be formed, and the travel distance of each member of the image forming unit such as the latent image bearer like the photoconductor drum or the image bearer such as the intermediate transfer belt 15 hardly increases due to formation of the toner image pattern.

Accordingly, at a formation timing before the start of the printing operation, without determining whether to form the toner image pattern or skip the formation of the toner image pattern, whenever the cumulative value of the indicator value, such as the required toner input amount, exceeds the threshold, the toner image pattern is formed. At the timings after the end of the printing operation, and in image adjustment, by determining whether to form the toner image pattern or to skip the formation of the toner image pattern so as to reduce the formation frequency of the toner image pattern, the increases in the travel distance of the components of the image forming units, such as the latent image bearer, and of the image bearer due to the formation of the toner image pattern can be minimized, while reducing wasteful toner consumption.

### Aspect 5

According to Aspect 5, in the image forming apparatus of Aspect 4, an image adjustment operation is executed, when an execution timing occurs, by suspending the printing operation, the first mode such as the BW mode (monochrome image forming mode) is executed in a state in which the image bearer such as the intermediate transfer belt 15 is separated from a latent image bearer of an image forming unit other than another latent image bearer such as the photoconductor drum of another image forming unit to be used, and for the printing operation suspended by execution of the image adjustment operation, a number of times of skipping the formation of the toner image pattern when the printing operation is in the second mode such as the FC mode (full-color image forming mode) is greater than a number of times of skipping the formation of the toner image pattern when the printing operation is in the first mode.

Accordingly, as described in Example 2, when the printing operation suspended by the execution of the image adjustment operation is in the second mode such as the FC mode, the multiple image forming units are driven at the time of forming the toner image pattern such as the scraping toner pattern, and thus, the travel distance of each member of the multiple image forming units is increased. On the other hand, in the first mode such as the BW mode, the mode is executed in a state that the latent image bearer other than the latent image bearer such as the photoconductor drum of the image forming unit to be used such as the Bk color image forming station is separated from the image bearer such as the intermediate transfer belt, and another image forming unit other than the image forming unit to be used can be stopped. Therefore, in the first mode, the travel distance of each member of the image forming unit other than the image forming unit to be used does not increase at the time of forming the toner image pattern.

Therefore, according to Aspect 5, the number of times of skipping the formation of the toner image pattern in the second mode is made larger than the number of times of skipping the formation of the toner image pattern in the first mode, and the formation frequency of the toner image pattern in the second mode is made lower than that in the first mode, and thus, the service life of the components of an image forming unit other than the image forming units used in the first mode can extend.

### Aspect 6

According to Aspect 6, in the image forming apparatus of Aspect 4 or 5, the first mode such as the BW mode (monochrome image forming mode) is executed in a state in which the image bearer such as the intermediate transfer belt 15 is separated from a latent image bearer of an image forming unit other than another latent image bearer such as the photoconductor drum of another image forming unit to be used, and, at a formation timing after an end of the printing operation, a number of times of skipping the formation of the toner image pattern when the printing operation is in the second mode such as the FC mode (full-color image forming mode) is greater than a number of times of skipping the formation of the toner image pattern when the printing operation is in the first mode.

Accordingly, for the same reason as described in Aspect 5, the service life of each member of the image forming unit other than the image forming unit used in the first mode can be extended.

### Aspect 7

According to Aspect 7, in the image forming apparatus of any one of Aspects 1 to 6, the control circuitry such as the image forming controller 82 changes the toner amount of the toner image pattern based on an input shortage rate of toner to the cleaning member such as the cleaning blade 31.

Accordingly, as described in Example 2, when the printing operation with a large number of printed sheets frequently occurs, the number of formation timings of the toner image input pattern decreases, and the toner input to the cleaning member such as the cleaning blade 31 is in shortage, the toner amount of the toner image pattern such as the scraping toner pattern can be increased. As a result, the toner amount input to the cleaning member can be increased, the scraping performance of filming can be improved, and deterioration of belt filming due to a shortage of toner input to the cleaning member can be prevented.

On the other hand, when the toner input shortage rate is low and the filming of the image bearer can be removed with the toner sufficiently input to the cleaning member, the toner amount of the toner image pattern such as the scraping toner pattern can be reduced. Accordingly, wasteful toner consumption can be reduced.

### Aspect 8

According to Aspect 8, in the image forming apparatus of Aspect 7, the input shortage rate is a ratio of a required toner input amount to the indicator value accumulated from a start of use, the required toner input amount being calculated based on the indicator value such as the toner input amount and a toner amount of the toner image pattern input to the cleaning member such as the cleaning blade 31.

Accordingly, as described in the embodiment, when the printing operation with a large number of printed sheets frequently occurs, the toner image pattern input to the cleaning member such as the cleaning blade 31 is not formed so much, and the toner input shortage occurs, the required toner input amount is not subtracted by the toner amount of the toner image pattern input to the cleaning member, and thus, the ratio of the required toner input amount to the indicator value accumulated from the start of use such as the total toner input amount increases. On the other hand, when there are many printing operations with a small number of printed sheets, the toner image pattern is frequently input to the cleaning member, and the toner input shortage does not occur, the ratio of the required toner input amount to the indicator value accumulated from the start of use becomes low. Therefore, the state of the toner input to the cleaning member can be satisfactorily grasped from the ratio of the required toner input amount to the total cumulative indicator value.

### Aspect 9

According to Aspect 9, in the image forming apparatus of any one of Aspects 1 to 8, the operation ratio such as the FC rate is calculated based on either a number of printed sheets in the second mode during a predetermined period or a travel distance of a latent image bearer included in the image forming units in the second mode during the predetermined period.

Accordingly, the operation ratio of the second mode with respect to the printing operation during the predetermined period can be calculated.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image bearer to bear a toner image;
multiple image forming stations to form the toner image on the image bearer, each of the multiple image forming stations including a latent image bearer;
a transfer member to transfer the toner image from the image bearer onto a sheet;
a cleaning member to clean a surface of the image bearer; and
control circuitry configured to:
control the image forming apparatus to operate in a first mode in which the toner image is formed on the image bearer by one image forming station of the multiple image forming stations, and a second mode in which the toner image is formed on the image bearer by the multiple image forming stations;
execute formation, on the image bearer, of a toner image pattern to be input to the cleaning member based on an indicator value, the indicator value being calculated by multiplying an indicator value conversion coefficient by either a travel distance of the latent image bearers of the multiple image forming stations in the second mode or a number of printed sheets in the second mode; and
change the indicator value conversion coefficient based on an operation ratio of the second mode during a predetermined period.

2. The image forming apparatus according to claim 1,
wherein, in a case that a required toner input amount calculated based on the indicator value and a toner amount of the toner image pattern input to the cleaning member exceeds a threshold, the control circuitry determines whether to form the toner image pattern or to skip formation of the toner image pattern, and sets a number of times of skipping formation of the toner image pattern based on the operation ratio.

3. The image forming apparatus according to claim 2, wherein
the toner image pattern is formed at a timing before a start of a printing operation for forming the toner image on the sheet, a timing after an end of the printing operation, and a timing in image adjustment, and
at the timing after the end of the printing operation and the timing in image adjustment, the control circuitry determines whether to form the toner image pattern or to skip formation of the toner image pattern.

4. The image forming apparatus according to claim 3, wherein
the control circuitry executes the image adjustment when an execution timing occurs, by suspending the printing operation,
in the first mode, the image bearer is separated from the latent image bearer of each of the multiple image forming stations other than the one image forming station to be used, and
for the printing operation suspended by execution of the image adjustment, a number of times of skipping formation of the toner image pattern when the printing operation is in the second mode is greater than a number of times of skipping formation of the toner image pattern when the printing operation is in the first mode.

5. The image forming apparatus according to claim 3, wherein
in the first mode, the image bearer is separated from the latent image bearer of each of the multiple image forming stations other than the one image forming station to be used, and
at a formation timing after an end of the printing operation, a number of times of skipping formation of the toner image pattern when the printing operation is in the second mode is greater than a number of times of skipping formation of the toner image pattern when the printing operation is in the first mode.

6. The image forming apparatus according to claim 1,
wherein the control circuitry changes a toner amount of the toner image pattern based on an input shortage rate of toner to the cleaning member.

7. The image forming apparatus according to claim 6,
wherein the input shortage rate is a ratio of a required toner input amount to the indicator value accumulated from a start of use, the required toner input amount being calculated based on the indicator value and a toner amount of the toner image pattern input to the cleaning member.

8. The image forming apparatus according to claim 1,
wherein the control circuitry calculates the operation ratio based on either the number of printed sheets in the second mode during the predetermined period or the travel distance of the latent image bearers of the image forming stations during the predetermined period.

9. An image forming apparatus comprising:
an image bearer to bear a toner image;
multiple image forming stations to form the toner image on the image bearer, each of the multiple image forming stations including a latent image bearer;
a transfer member to transfer the toner image from the image bearer onto a sheet;
a cleaning member to clean a surface of the image bearer; and
control circuitry configured to:
control the image forming apparatus to operate in a first mode in which the toner image is formed on the image bearer by one image forming station of the multiple image forming stations, and a second mode in which the toner image is formed on the image bearer by the multiple image forming stations;
control formation, on the image bearer, of a toner image pattern to be input to the cleaning member; and
in a case that a required toner input amount calculated based on an indicator value and a toner amount of the toner image pattern input to the cleaning member exceeds a threshold, determine whether to form the toner image pattern or to skip formation of the toner image pattern, and set a number of times of skipping formation of the toner image pattern based on an operation ratio of the second mode during a predetermined period,
the indicator value being calculated by multiplying an indicator value conversion coefficient by either a travel distance of the latent image bearers of the multiple image forming stations in the second mode or a number of printed sheets in the second mode.

10. The image forming apparatus according to claim 9,
wherein the control circuitry calculates the operation ratio based on either the number of printed sheets in the second mode during the predetermined period or the travel distance of the latent image bearers of in the image forming stations during the predetermined period.

11. The image forming apparatus according to claim 9, wherein
the toner image pattern is formed at a timing before a start of a printing operation for forming the toner image on the sheets, a timing after an end of the printing operation, and a timing in image adjustment, and
at the timing after the end of the printing operation and the timing in the image adjustment, the control circuitry determines whether to form the toner image pattern or to skip formation of the toner image pattern.

12. The image forming apparatus according to claim 11, wherein
the control circuitry executes the image adjustment, when an execution timing occurs, by suspending the printing operation,
in the first mode, the image bearer is separated from the latent image bearer of each of the multiple image forming stations other than the one image forming station to be used, and
for the printing operation suspended by execution of the image adjustment, a number of times of skipping formation of the toner image pattern when the printing operation is in the second mode is greater than a number of times of skipping formation of the toner image pattern when the printing operation is in the first mode.

13. The image forming apparatus according to claim 11, wherein
in the first mode, the image bearer is separated from the latent image bearer of each of the multiple image forming stations other than the one image forming station to be used, and
at a formation timing after an end of the printing operation, a number of times of skipping formation of the toner image pattern when the printing operation is in the second mode is greater than a number of times of skipping formation of the toner image pattern when the printing operation is in the first mode.

14. The image forming apparatus according to claim 9,
wherein the control circuitry changes a toner amount of the toner image pattern based on an input shortage rate of toner to the cleaning member.

15. The image forming apparatus according to claim 14,
wherein the input shortage rate is a ratio of a required toner input amount to the indicator value accumulated from a start of use, the required toner input amount being calculated based on the indicator value and a toner amount of the toner image pattern input to the cleaning member.

16. A method for forming an image by an image forming apparatus having a first mode in which a toner image is formed on an image bearer by one of multiple image forming station, and a second mode in which the toner image is formed on the image bearer by the multiple image forming stations, the method comprising:
forming, on the image bearer, a toner image pattern to be input to a cleaning member based on an indicator value, the indicator value being calculated by multiplying an indicator value conversion coefficient by either a travel distance of latent image bearers of the multiple image forming stations in the second mode or a number of printed sheets in the second mode,
wherein the indicator value conversion coefficient is changed based on an operation ratio of the second mode during a predetermined period.
